(19) United States
(12) Patent Application Publication
(10) Pub. No.: US 2026/0010391 A1
(43) Pub. Date: Jan. 8, 2026

(54) HARDWARE ACCELERATOR AND CONTROL METHOD

(71) Applicant: Fujitsu Limited, Kawasaki-shi (JP)

(72) Inventor: Yutaka TAMIYA, Yokohama (JP)

(73) Assignee: Fujitsu Limited, Kawasaki-shi (JP)

(21) Appl. No.: 19/234,379

(22) Filed: Jun. 11, 2025

(30) Foreign Application Priority Data
Jul. 5, 2024 (JP) 2024-109138

(51) Int. Cl. G06F 9/48; G06F 9/50

(52) U.S. Cl. CPC G06F 9/4806; G06F 9/5027; G06F 2209/481

(57) ABSTRACT

A hardware accelerator having a plurality of processing elements, the hardware accelerator includes: an exception detector that detects an occurrence of an exception during an execution of a computation by the plurality of processing elements, and an execution controller that, in response to the exception detector detecting the exception, causes the plurality of processing elements to sequentially re-execute the computation in which the occurrence of the exception has been detected, using re-execution information that has been used by at least a part of the plurality of processing elements for the execution of the computation and has been saved in a re-execution information storage before the detection of the exception.

### CROSS-REFERENCE TO RELATED APPLICATION

This application is based upon and claims the benefit of priority of the prior Japanese Patent application No. 2024-109138, filed on Jul. 5, 2024, the entire contents of which are incorporated herein by reference.

### FIELD

The present disclosure relates to a hardware accelerator and a control method.

### BACKGROUND

Since High-Performance Computing (HPC) applications and Machine Learning (ML) applications require enormous calculations, an improvement in the processing speed of these applications using a hardware accelerator has been demanded. A hardware accelerator may also be simply referred to as an accelerator.

A typical accelerator has a large number of processing circuits, and a large amount of data is processed simultaneously and at high speed in these processing circuits. Processing circuits may also be referred to as processing elements (PEs).

During a computation by the accelerator, an exception may occur. An exception may refer to an unusual circumstance that deviates from the normal operational flow of an information processing apparatus. Known types of exceptions include division by zero, overflow, underflow, and Not a Number (NaN).

The causes of exceptions vary and may include input data and algorithms. A debugging operation is performed to eliminate exceptions that occur on the accelerator. Improving the efficiency of the debugging operation is demanded.

In debugging support techniques for conventional accelerators, for example, one or more breakpoints are set in advance in the target program and the program is executed step by step by repeatedly pausing and resuming at each breakpoint (see, for example, Japanese Laid-Open Patent Publication No. 2010-224766).

For example, related arts are disclosed in Japanese Laid-Open Patent Publication No. 2010-224766, Japanese Laid-Open Patent Publication No. 2010-102732, and US Patent Application Publication No. 2019/0303263.

### SUMMARY

According to an aspect of the embodiments, a hardware accelerator having a plurality of processing elements, the hardware accelerator includes: an exception detector that detects an occurrence of an exception during an execution of a computation by the plurality of processing elements, and an execution controller that, in response to the exception detector detecting the exception, causes the plurality of processing elements to sequentially re-execute the computation in which the occurrence of the exception has been detected, using re-execution information that has been used by at least a part of the plurality of processing elements for the execution of the computation and has been saved in a re-execution information storage before the detection of the exception.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating the hardware configuration of an accelerator according to one embodiment;

FIG. 2 is a diagram illustrating the functional configuration of the accelerator according to one embodiment;

FIG. 3 is a flowchart for describing processing in the accelerator according to one embodiment; and

FIG. 4 is a flowchart for describing the details of the processing in Step S6 in the flowchart in FIG. 3.

### DESCRIPTION OF EMBODIMENT(S)

However, such conventional debugging support techniques require breakpoints to be set in advance, which is cumbersome and limits the flexibility of debugging. Furthermore, because a large number of PEs operate simultaneously in the accelerator, it is difficult to identify the location and cause of the exception. Furthermore, even if the system is observed by using the debugger after detecting an exception, in many cases, the data that triggered the exception has already been lost, making it difficult to identify the location and cause of the exception.

Hereinafter, an embodiment according to the present hardware accelerator and control method will be described with reference to the drawings. However, the embodiment described below is merely exemplary and is not intended to exclude various modifications or applications of the technology not explicitly stated in the embodiment. In other words, the present embodiment can be embodied with various modifications without departing from the spirit thereof. In addition, each drawing does not imply that only the elements illustrated in the drawing are provided, but other functions or the like may also be included.

### (A) CONFIGURATION

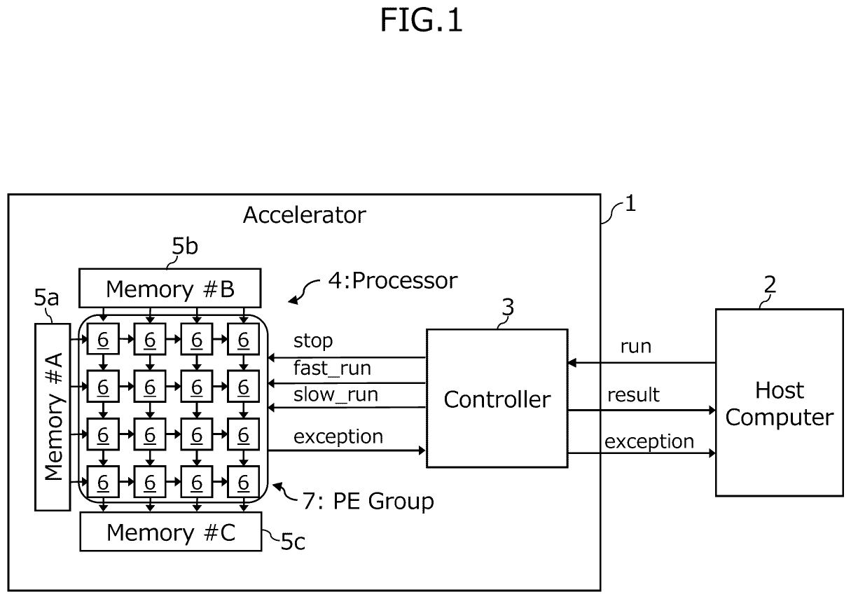

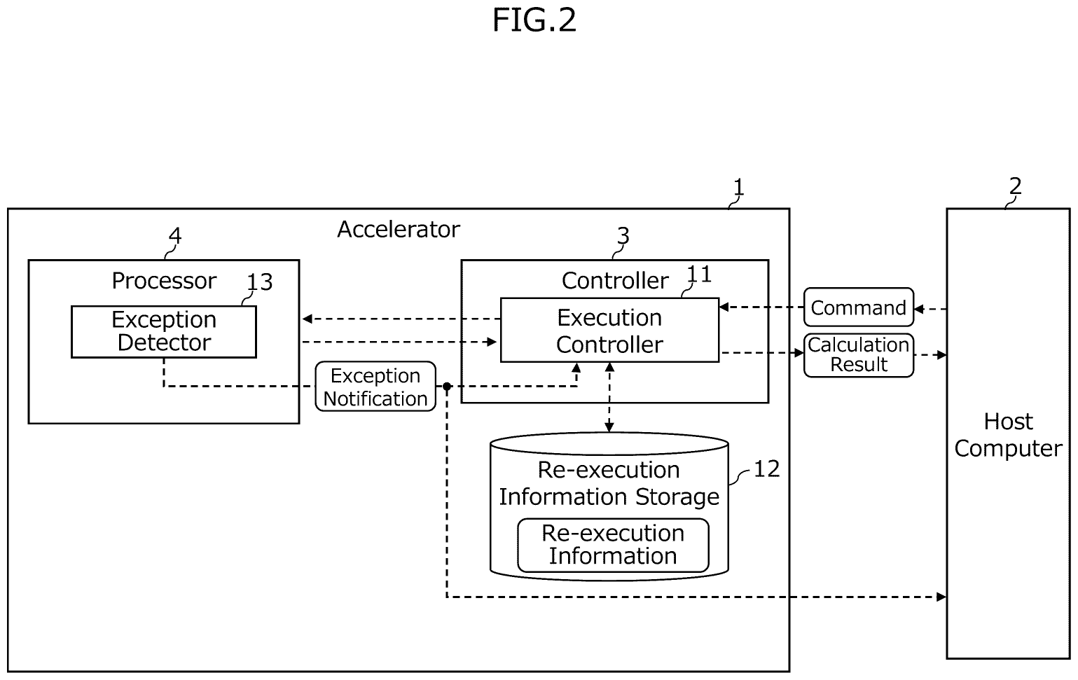

FIG. 1 is a diagram illustrating the hardware configuration of an accelerator 1 according to one embodiment, and FIG. 2 is a diagram illustrating the functional configuration thereof.

The accelerator 1 is a hardware accelerator having a function for performing computations and is, for example, connected to a host computer 2. In the example described below, an example in which the accelerator 1 performs matrix operations as one example of computation, particularly, the accelerator 1 is a matrix product processor that performs matrix product calculations (matrix multiplications), is described. The accelerator 1 performs a matrix computation A×B=C using the matrices A and B, as a matrix product. The matrices A and B may be complex matrices.

The host computer 2 may be, for example, an HPC or a personal computer and may be embodied in various modifications.

The host computer 2 issues a command (run) instructing an execution of a computation (matrix product computation) to the accelerator 1, thereby causing the accelerator 1 to perform the calculation of the matrix product. The host computer 2 receives a computation result from the accelerator 1.

Additionally, in response to an exception notification (exception signal) being input from an exception detector 13 (described later) in the accelerator 1, the host computer 2 executes a debugger program (hereinafter simply referred to as the “debugger”) to perform debugging.

In the debugging, various operations are performed. For example, the value of a register in a certain PE 6 provided in a processor 4 in the accelerator 1 is read, or the values in memories 5a, 5b, and 5c are read and the values are compared with expected values.

As illustrated in FIG. 1, the accelerator 1 includes a controller 3 and the processor 4.

The processor 4 performs computations according to commands issued by the host computer 2. The processor 4 is a matrix processor having a two-dimensional systolic array configuration and performs computations of matrix products (A×B=C). The processor 4 includes the memories 5a, 5b and a PE group 7 having a plurality of PEs 6, and 5c. The PEs 6 represent examples of processing elements.

In the PE group 7, the plurality of PEs 6 are arranged in a two-dimensional grid in both the row and column directions. In FIG. 1, the horizontal direction corresponds to the row direction, and the vertical direction corresponds to the column direction.

In the example illustrated in FIG. 1, the PE group 7 has 16 PEs 6, which are arranged in the two-dimensional grid of 4 rows×4 columns.

Each PE 6 constituting the PE group 7 arranged in the two-dimensional grid may be specified by the coordinate combining row and column values. For example, in the PE group 7 illustrated in FIG. 1, the coordinate (0, 0) specifies the PE 6 at the upper-left corner of the two-dimensional grid, while the coordinate (3, 3) specifies the PE 6 at the lower-right corner of the two-dimensional grid.

Each PE 6 is a processing element that performs computations (matrix product computations). Each PE 6 has a register capable of storing information (data). In the plurality of PEs 6 (PE group 7) arranged in the two-dimensional grid, for example, a matrix A may be input from the left end of the two-dimensional grid, while a matrix B may be input from the top end of the two-dimensional grid, wherein each matrix A and B may be (submatrices) obtained by dividing respective original matrices. Additionally, the calculation result of the matrix product by the plurality of PEs 6 (PE group 7) may be output as a matrix C from the bottom end of the two-dimensional grid.

In FIG. 1, the arrows connecting the plurality of PEs 6 indicate the flow of data, where data is transferred to the PEs 6 at the subsequent stages at each clock cycle.

For example, in each row, the data of the matrix A entered from the first PEs 6 is sequentially passed to the next PEs 6 connected in a cascade. Similarly, in each column, the data of the matrix B entered from the first PEs 6 is sequentially passed to the next PEs 6 connected in a cascade.

In each PE 6, a matrix multiplication is performed using the data of the matrix A and the data of the matrix B. The computation result may be accumulated with the previous result.

In the example illustrated in FIG. 1, the memory 5a (labeled as “Memory #A” in FIG. 1) is connected to each PE 6 constituting the head of each row (first column) in the two-dimensional grid (PE group 7). The matrix A is stored in the memory 5a, and the information constituting the matrix A read from the memory 5a is input into the PE group 7.

The memory 5a represents one example of a first memory that stores information to be input into each PE 6 constituting the first column of the plurality of PEs 6 (processing elements).

Similarly, the memory 5b (labeled as “Memory #B” in FIG. 1) is connected to each PE 6 constituting the head of each column (first row) in the two-dimensional grid (PE group 7). The matrix B is stored in the memory 5b, and the information constituting the matrix B read from the memory 5b is input into the PE group 7.

The memory 5b represents one example of a second memory that stores information to be input into each PE 6 constituting the first row of the plurality of PES 6 (processing elements).

The memory 5c (labeled as “Memory #C” in FIG. 1) is connected to each PE 6 constituting the tail of each column (last row) in the two-dimensional grid (PE group 7). The calculation result of the matrix product of the matrix A and the matrix B performed in the PE group 7 is stored in the memory 5c. At least a part of the memories 5a, 5b, and 5c may be a scratchpad memory.

Additionally, timing adjustment blocks (not illustrated) may be provided, between the memory 5a and the PE group 7, and between the memory 5b and the PE group 7, to adjust the timing to input the matrices A and B from the memories 5a and 5b to the PE group 7. The timing adjustment blocks adjust the input so that the elements constituting the matrices A and B are input simultaneously to each PE 6 constituting the first row (topmost row in the example illustrated in FIG. 1) and the first column (leftmost column in the example illustrated in FIG. 1) of the PE group 7.

As illustrated in FIG. 2, the processor 4 has the function as an exception detector 13.

When the exception detector 13 detects a state meeting a given error condition, such as division by zero, during a calculation executed by the PEs 6, the exception detector 13 may determine that an exception is detected. The exception detector 13 may detect error states meeting various error conditions, such as division by zero, overflow, underflow, Not a Number (NaN), and protection violations, as exceptions. It should be noted that the function of the exception detector 13 can be embodied by various known methods, and a detailed description thereof is omitted.

In response to detecting an exception during a computation in the PE group 7, the exception detector 13 generates an exception notification and sends the exception notification to an execution controller 11, which will be described later, and the host computer 2. The exception notification is a signal that notifies the occurrence of the exception. The signal of the exception notification may also be referred to as the exception signal. The exception detector 13 may notify the execution controller 11 and the host computer 2 of the exception notification via an interrupt.

For example, when the exception detector 13 in the processor 4 detects an exception during the execution of a command sent from the host computer 2, the command that triggered the exception during the execution thereof may be referred to as the “exception-triggering command”.

The controller 3 controls the execution of the computation of a matrix product by the processor 4. As illustrated in FIG. 2, the controller 3 has the function as the execution controller 11.

In response to receiving a command, such as one instructing an execution of a computation, from the host computer 2, the execution controller 11 controls the operation of the processor 4.

For example, in response to receiving a command (e.g., a run command) instructing an execution of a matrix product computation from the host computer 2, the execution controller 11 causes the processor 4 to perform the calculation of the matrix product. For example, the execution controller 11 may cause the processor 4 to perform the calculation of the matrix product by inputting a fast_run signal to the processor 4. The execution controller 11 sends the calculation result of the matrix product (result) by the processor 4 to the host computer 2.

Furthermore, in response to receiving an exception notification (exception signal) from the exception detector 13 (processor 4), the execution controller 11 causes all PEs 6 in the processor 4 to stop the calculation of the matrix product. The processor 4 may cause the PEs 6 to stop the calculation of the matrix product by inputting a stop signal to the processor 4.

Furthermore, before the execution controller 11 causes the processor 4 to execute a computation based on a command received from the host computer 2, the execution controller 11 may cause re-execution information to be saved in a re-execution information storage 12.

The re-execution information is information that enables an execution (re-execution) of a computation in the PE group 7 and may include, for example, the information stored in the memory 5a and the memory 5b immediately before the execution of the exception-triggering command. However, the re-execution information is not limited to such information. For example, the re-execution information may also be the information stored in the register in each PE 6 in the PE group 7 immediately before the execution of the exception-triggering command, and various modifications can be embodied.

In the present embodiment, an example will be described in which the re-execution information is the information stored in the memory 5a and the memory 5b immediately before the execution of the exception-triggering command. When the command is executed, both the matrix A stored in the memory 5a and the matrix B stored in the memory 5b are merely read from the memories 5a and 5b without any further operation. Therefore, at the moment when the exception detector 13 detects an exception during the execution of the command, the information stored in the memory 5a and the memory 5b remains unchanged from before the execution of the command. Thus, by using the information stored in the memory 5a and the memory 5b at the time when the exception occurs as re-execution information, the state before the occurrence of the exception can be reproduced.

Accordingly, in this accelerator 1, the information stored in the memory 5a and the memory 5b at the time when the exception occurs is used as the re-execution information. That is, the memory 5a and the memory 5b function as the re-execution information storage 12 that stores the re-execution information.

During debugging, the execution controller 11 uses the re-execution information stored in the re-execution information storage 12 to reproduce the state before the execution of the exception-triggering command, in other words, the state before the occurrence of the exception.

For example, the execution controller 11 may reproduce the state before the occurrence of the exception in the processor 4 by restoring the re-execution information read from the re-execution information storage 12 to the location where the re-execution information was stored before the execution of the exception-triggering command.

As described above, since the re-execution information is the information stored in the memory 5a and the memory 5b and, at the same time, these memory 5a and memory 5b serve as the re-execution information storage 12 in the present embodiment, the execution controller 11 can reproduce the state before the occurrence of the exception without requiring explicitly transferring (reading and storing) the re-execution information.

The execution controller 11 re-executes the exception-triggering command in the debug mode in the processor 4 where the state before the occurrence of the exception has been reproduced. The execution controller 11 may, for example, cause the exception-triggering command to be re-executed in the debug mode by inputting a slow run signal to the processor 4.

In the debug mode, the execution controller 11 sequentially performs the computation in each of the plurality of PEs 6 in the PE group 7 one step at a time.

The execution controller 11, in response to the exception detector 13 detecting an exception, causes the plurality of PEs 6 to sequentially re-execute the computation in which the occurrence of the exception was detected, using the re-execution information that was used by at least a part of the plurality of PEs 6 for the execution of the computation and was saved in the re-execution information storage 12 before the detection of the exception.

For example, in the processor 4 exemplified in FIG. 1, the execution controller 11 causes each PE 6 in the PE group 7 to sequentially execute (re-execute) the computation, starting from the PE 6 at the first coordinate (0,0) in order.

In the example illustrated in FIG. 1, during debugging using the re-execution information, an exception will occur in one of the PEs 6 at the coordinates from (0, 0) to (3, 3). Here, it is assumed that an exception occurs in the PE 6 at the coordinate (2,1) during the re-execution in debugging, for example.

The exception detector 13 detects the exception also during debugging and issues an exception notification to the execution controller 11 and the host computer 2. In response to the exception notification being input, the execution controller 11 stops the operation of the accelerator 1.

The debugger on the host computer 2 may identify the cause of the exception by performing an analysis, such as examining the register value, etc., of each PE 6 and comparing it with the expected value. For example, the debugger may detect that the register value of the PE 6 at the coordinate (2, 1) differs from the expected value and identify the PE 6 at the coordinate (2,1) as the cause of the exception.

### (B) OPERATION

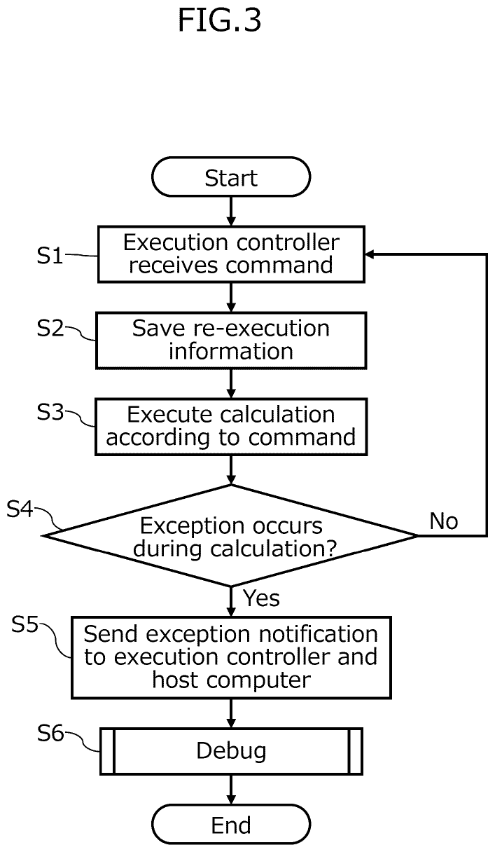

The processing in the accelerator 1 according to one embodiment configured as described above will be described with reference to the flowchart illustrated in FIG. 3 (Steps S1 to S6).

In Step S1, the execution controller 11 receives a command from the host computer 2 for executing a computation of a matrix product.

In Step S2, before causing the processor 4 to execute the computation according to the command received from the host computer 2, the execution controller 11 causes re-execution information to be saved in the re-execution information storage 12. However, as described above, because the re-execution information is the information stored in the memory 5a and the memory 5b and these memories 5a and 5b function as the re-execution information storage 12 in the present embodiment, the execution controller 11 does not need to explicitly transfer the re-execution information.

In Step S3, the execution controller 11 causes the processor 4 to execute the computation according to the command received from the host computer 2, causing the processor 4 to perform the computation of the matrix product according to the command.

In Step S4, the exception detector 13 checks whether an exception occurs during the computation. If no exception occurs during computation (see the No route in Step S4), the processing returns to Step S1.

On the other hand, if an exception has occurred during the computation (see the Yes route in Step S4), the processing proceeds to Step S5. In Step S5, the exception detector 13 sends an exception notification to the execution controller 11 and the host computer 2.

In Step S6, debugging of the accelerator 1 is performed, and the processing is then terminated.

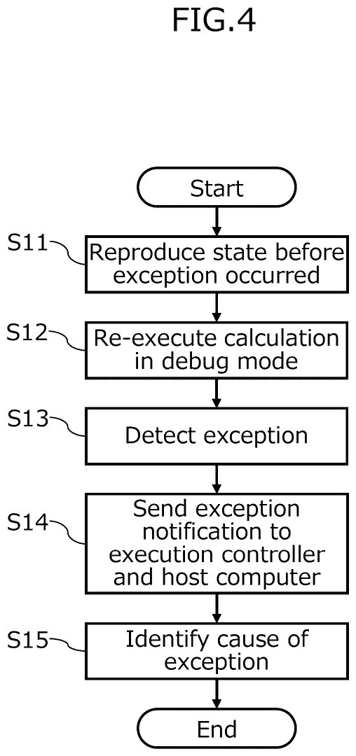

Next, the details of the processing in Step S6 in the flowchart in FIG. 3 will be described with reference to the flowchart illustrated in FIG. 4 (Steps S11 to S15).

In Step S11, the execution controller 11 reproduces the state before the occurrence of the exception using the re-execution information saved in the re-execution information storage 12. However, as described above, the re-execution information is the information stored in the memory 5a and the memory 5b and these memories 5a and 5b function as the re-execution information storage 12 in the present embodiment. Therefore, the state before the occurrence of the exception is reproduced without requiring explicitly transferring the re-execution information by the execution controller 11.

In Step S12, the execution controller 11 re-executes the exception-triggering command in the debug mode in the processor 4 where the state before the occurrence of the exception has been reproduced. As a result, the computation instructed by the command is re-executed sequentially (for example, on a clock-by-clock basis) by the plurality of PES 6.

In Step S13, the exception detector 13 detects an exception during the re-execution of the command in the debug mode. In Step S14, the exception detector 13 notifies the execution controller 11 and the host computer 2 of an exception notification. In response to the exception notification being input, the execution controller 11 stops the operation of all PEs 6 in the accelerator 1 via a stop signal.

In Step S15, the debugger on the host computer 2 examines the register value of the PE 6 in which the exception occurred or the like, to identify the cause of the exception.

### (C) EFFECTS

As described above, according to the accelerator 1 of the present embodiment, when an exception occurs in the processor 4, the execution controller 11 re-executes the exception-triggering command in the debug mode using the re-execution information. Specifically, the execution controller 11 re-executes the exception-triggering command in the debug mode in the processor 4 where the state before the occurrence of the exception has been reproduced.

In this debug mode, the computation in which the occurrence of the exception has been detected is sequentially re-executed by the plurality of PEs 6. Since the exception-triggering command is re-executed in the processor 4 where the state before the occurrence of the exception has been reproduced, the exception detector 13 detects an exception again and issues an exception notification to the execution controller 11 and the host computer 2.

In response to the exception notification being input, the execution controller 11 stops the computation performed by the processor 4. Therefore, it appears from the host computer 2 as if the computation is stopped in the PE 6 where the exception occurred. As a result, the debugger on the host computer 2 can immediately investigate the cause of the exception, enabling real-time debugging.

In response to the exception notification being input by the exception detector 13 as a result of the detection of the exception, the execution controller 11 immediately stops the operation of all PEs 6 in the accelerator 1 via a stop signal. As a result, the information stored in the memories 5a and 5b immediately before the execution of the command, in which the exception was detected, remains unchanged.

Accordingly, during debugging, the execution controller 11 can easily reproduce the state of the processor 4 at the moment when the exception occurred by re-executing the exception-triggering command by utilizing the values of the matrices A and B stored in the memories 5a and 5b as they are, which is highly convenient.

Because the memories 5a and 5b are used as the re-execution information storage 12, a dedicated storing device for saving re-execution information is not required, allowing for low-cost implementation.

Additionally, when no exception occurs in the processor 4, the effect of a high-speed operation through parallel computations by the plurality of PEs 6 is also advantageously achieved.

### (D) OTHERS

Each configuration and process of the present embodiment may be selectively adopted as necessary or appropriately combined.

Furthermore, the disclosed technique is not limited to the above-described embodiment and may be embodied in various modifications without departing from the spirit of the present embodiment.

For example, although the example has been described where the re-execution information is the information stored in the memory 5a and the memory 5b immediately before the execution of the command and the memory 5a and the memory 5b function as the re-execution information storage 12 in the above-described embodiment, this is not limiting.

For example, the accelerator 1 may have a storing device such as a memory, which is not illustrated, and this storing device may save the re-execution information to thereby function as the re-execution information storage 12.

Furthermore, the example has been described in which the accelerator 1 performs a matrix computation as one example of computation, specifically, the accelerator 1 is a matrix product processor performing matrix product computations (matrix multiplications) in the above-described embodiment. However, the present disclosure is not limited thereto. The accelerator 1 may perform matrix computations other than matrix products, or may also perform computations other than matrix computations, and various modifications may be made.

Furthermore, the present embodiment can be embodied and manufactured by those skilled in the art based on the above-described disclosure.

According to one embodiment, debugging operations can be performed efficiently when exceptions occur in a hardware accelerator.

Throughout the descriptions, the indefinite article “a” or “an”, or adjective “one” does not exclude a plurality.

All examples and conditional language recited herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A hardware accelerator having a plurality of processing elements, the hardware accelerator comprising:
an exception detector that detects an occurrence of an exception during an execution of a computation by the plurality of processing elements, and
an execution controller that, in response to the exception detector detecting the exception, causes the plurality of processing elements to sequentially re-execute the computation in which the occurrence of the exception has been detected, using re-execution information that has been used by at least a part of the plurality of processing elements for the execution of the computation and has been saved in a re-execution information storage before the detection of the exception.

2. The hardware accelerator according to claim 1, wherein
the plurality of processing elements have a two-dimensional systolic array configuration,
the hardware accelerator further comprises a first memory and a second memory each functioning as the re-execution information storage, the first memory storing information to be input to each of the plurality of processing elements configuring a first column of the plurality of processing elements, the second memory storing information to be input to each of the plurality of processing elements configuring a first row of the plurality of processing elements, and
the execution controller causes the re-execution of the computation using the re-execution information read from the first memory and the second memory.

3. The hardware accelerator according to claim 1, wherein
the computation is a matrix computation.

4. A control method comprising a process comprising, in a hardware accelerator having a plurality of processing elements:
detecting an occurrence of an exception during an execution of a computation by the plurality of processing elements; and
causing the plurality of processing elements to sequentially re-execute the computation in which the occurrence of the exception has been detected, using re-execution information that has been used by at least a part of the plurality of processing elements for the execution of the computation and has been saved in a re-execution information storage before the detection of the exception.

5. The control method according to claim 4, wherein
the plurality of processing elements have a two-dimensional systolic array configuration,
the hardware accelerator further comprises a first memory and a second memory each functioning as the re-execution information storage, the first memory storing information to be input to each of the plurality of processing elements configuring a first column of the plurality of processing elements, the second memory storing information to be input to each of the plurality of processing elements configuring a first row of the plurality of processing elements, and
the re-executing the computation comprising causing the re-execution of the computation using the re-execution information read from the first memory and the second memory.

6. The control method according to claim 4, wherein
the computation is a matrix computation.
